(19) United States
(12) Patent Application Publication
(10) Pub. No.: US 2016/0068275 A1
(43) Pub. Date: Mar. 10, 2016

(54) LOCKING MEMBER WITH SEALING INSERT AND CHANNEL

(71) Applicant: Alcoa Inc., Pittsburgh, PA (US)

(72) Inventors: Gregory Rizza, Westminster, CA (US); Luke Haylock, Culver City, CA (US); Andreas Liebscher, San Diego, CA (US); Hasim Mulazimoglu, La Habra, CA (US); Wudhidham Prachumsri, Torrance, CA (US); Rodrigo Pinheiro, Riverside, CA (US); Manish Kamal, Seal Beach, CA (US)

(73) Assignee: ALCOA INC., Pittsburgh, PA (US)

(21) Appl. No.: 14/847,572

(22) Filed: Sep. 8, 2015

Related U.S. Application Data
(60) Provisional application No. 62/048,011, filed on Sep. 9, 2014.

(51) Int. Cl. B64D 45/02; F16B 39/28

(52) U.S. Cl. CPC B64D 45/02; F16B 39/28

(57) ABSTRACT

A locking member includes a body having a first end, a second end opposite the first end, a bore extending through the body from the first end to the second end, a bearing surface at the first end, fastening means for securing the locking member to a pin member, and a channel formed within the bearing surface and surrounding the bore. The locking member also includes a first insert located within the channel. The first insert is adapted such that, when the locking member is secured against a surface of a workpiece, the first insert prevents passage of a sparking material from within the bore of the locking member.

### CROSS-REFERENCE TO RELATED APPLICATION

This application is a Section 111(a) application relating to and claiming the benefit of commonly-owned, co-pending U.S. Provisional Patent Application Ser. No. 62/048,011, entitled “NUT/COLLAR WITH SEALING INSERT AND CHANNEL,” filed Sep. 9, 2014, the entirety of which is incorporated herein by reference.

### FIELD OF THE INVENTION

The present invention relates to fasteners and, more particularly, to fastener nuts and collars for lightning strike protection.

### BACKGROUND OF THE INVENTION

Continuous fiber reinforced composites are extensively used in both primary and secondary aircraft components for a variety of applications where light weight, high strength and corrosion resistance are primary concerns. Composites are typically composed of fine carbon fibers that are oriented at certain directions and surrounded in a supportive polymer matrix. Since the plies of the composite material are arranged at a variety of angles, and depending upon the direction of major loading, the resultant structure is typically a stacked laminated structure, which is highly anisotropic and heterogeneous. A significant portion of the composite structure is fabricated as near net-shape, but is drilled in order to facilitate joining of components using mechanical fasteners. Fastener holes drilled in composite materials do not exhibit comparable uniformity to that of fastener holes drilled in aluminum or steel, since individual carbon fibers fracture at irregular angles and form microscopic voids between the fastener and the hole. As the cutting tool used to drill such holes wears down, there is an increase of surface chipping and an increase in the amount of uncut fibers or resin and delamination. The composite microstructure containing such defects is referred to as “machining-induced micro texture.”

In addition to their machining challenges, composite structures in aircraft are more susceptible to lightning damage than metallic structures. Metallic materials, such as aluminum, are very conductive and therefore are able to dissipate the high currents resulting from a lightning strike. Carbon fibers are 100 times more resistive than aluminum to the flow of current. Epoxy, which is often used as a matrix in conjunction with carbon fibers, is 1 million times more resistive than aluminum. Moreover, the composite structural sections of an aircraft often behave like anisotropic electrical conductors (i.e., they exhibit different electrical resistance in different directions). Consequently, lightning protection of a composite structure is more complex, due to the intrinsic high resistance of carbon fibers and epoxy, the multi-layer construction, and the anisotropic nature of the structure. Some estimates indicate that, on average, each commercial aircraft in service is struck by lightning at least once per year. Aircraft flying in and around thunderstorms are often subjected to direct lightning strikes as well as to nearby lightning strikes, which may produce corona and streamer formations on the aircraft. In such cases, the lightning discharge typically originates at the aircraft and extends outward from the aircraft. While the discharge is occurring, the point of attachment moves from the nose of the aircraft and into the various panels that compromise the skin of the aircraft. The discharge usually leaves the aircraft structure through the empennage.

The protection of aircraft fuel systems against fuel vapor ignition due to lightning is even more critical. Since commercial aircraft contain relatively large amounts of fuel and also include very sensitive electronic equipment, they are required to comply with a specific set of requirements related to lightning strike protection in order to be certified for operation. Fasteners are often the primary pathways for the conduction of the lightning currents from skin of the aircraft to supporting structures such as spars or ribs, and poor electrical contact between the fastener body and the parts of the structure can lead to detrimental fastener arcing or sparking.

In the event of a lightning strike to an aircraft, several strategies are employed to mitigate the possibility of sparking occurring around fasteners. To avoid the potential for ignition of fuel by a lightning strike at the interface between a fastener and a composite structure in which the fastener is installed, one of these strategies involves the containment of sparking material (i.e., hot gases and particles caused by the creation of plasma during a lightning strike) that might be ejected from fastener holes, on the locking member side of the fastener.

### SUMMARY OF THE INVENTION

In an embodiment, a locking member includes a body having a first end, a second end opposite the first end, a bore extending through the body from the first end to the second end, a bearing surface at the first end, fastening means for securing the locking member to a pin member, and a channel formed within the bearing surface and surrounding the bore. The locking member also includes a first insert located within the channel. The first insert is adapted such that, when the locking member is secured against a surface of a workpiece, the first insert prevents passage of a sparking material from within the bore of the locking member.

In an embodiment, the fastening means includes a thread formed within at least a portion of the bore. In an embodiment, the body includes a neck portion proximate the second end and a flanged portion proximate the first end. A diameter of the flanged portion is greater than a diameter of the neck portion. In an embodiment, the neck portion is hexagonal.

In an embodiment, the body includes one or more of titanium, aluminum, nickel, and steel. In an embodiment, the first insert includes a material including one or more of a polymer, an elastomer, a ceramic, a glass, and a metal coated with a non-conductive layer. In an embodiment, the non-conductive layer includes one or more of polytetrafluoroethylene, silicone, and a dielectric high voltage insulator. In an embodiment, the first insert is friction fit within the channel, secured within the channel by an epoxy, or formed within the channel by deposition and curing.

In an embodiment, the body includes an enlarged counterbore extending from the first end to a point intermediate the first and second ends. In an embodiment, the enlarged counterbore includes an annular portion proximate the point. In an embodiment, the locking member also includes a second insert positioned within the enlarged counterbore. In an embodiment, the second insert includes a flanged portion engaging the annular portion of the enlarged counterbore.

In an embodiment, the second insert includes a material including one or more of a polymer, an elastomer, a ceramic, a glass, and a metal coated with a non-conductive layer. In an embodiment, the non-conductive layer of the second insert includes one or more of polytetrafluoroethylene, silicone, and a dielectric high voltage insulator. In an embodiment, the material of the second insert is identical to the material of the first insert. In an embodiment, the material of the second insert is different from the material of the first insert. In an embodiment, the locking member also includes a foam-like material located within the counterbore. In an embodiment, the foam-like material has a material-to-air ratio that is less than or equal to 1.

In an embodiment, a fastener includes a pin member adapted to be installed within aligned holes in a plurality of workpieces. The fastener also includes a locking member including a body having a first end, a second end opposite the first end, a bore extending through the body from the first end to the second end, a bearing surface at the first end, fastening means for securing the locking member to the pin member, and a channel formed within the bearing surface and surrounding the bore. The locking member also includes an insert located within the channel. The insert is adapted such that, when the locking member is secured against a surface of one of the workpieces, the insert prevents passage of a sparking material from within the bore of the fastener.

In an embodiment, the locking member is one of a nut adapted to threadedly engage the pin member, and a swage collar adapted to be swaged onto the pin member.

### BRIEF DESCRIPTION OF THE DRAWINGS

FIG. 1 is a side cross-sectional view of a first embodiment of a locking member;

FIG. 2 is a bottom perspective view of the locking member shown in FIG. 1, with a channel formed in a bearing surface of the locking member including an insert positioned therein;

FIG. 3 is a bottom perspective view of a second embodiment of a locking member, with a channel formed in a bearing surface of the locking member including a first insert positioned therein and an enlarged counterbore of a central bore of the locking member including a second insert positioned therein ;

FIG. 4 is a side cross-sectional view of the locking member shown in FIG. 3; and

FIG. 5 is a side cross-sectional view of a third embodiment of a locking member.

### DETAILED DESCRIPTION

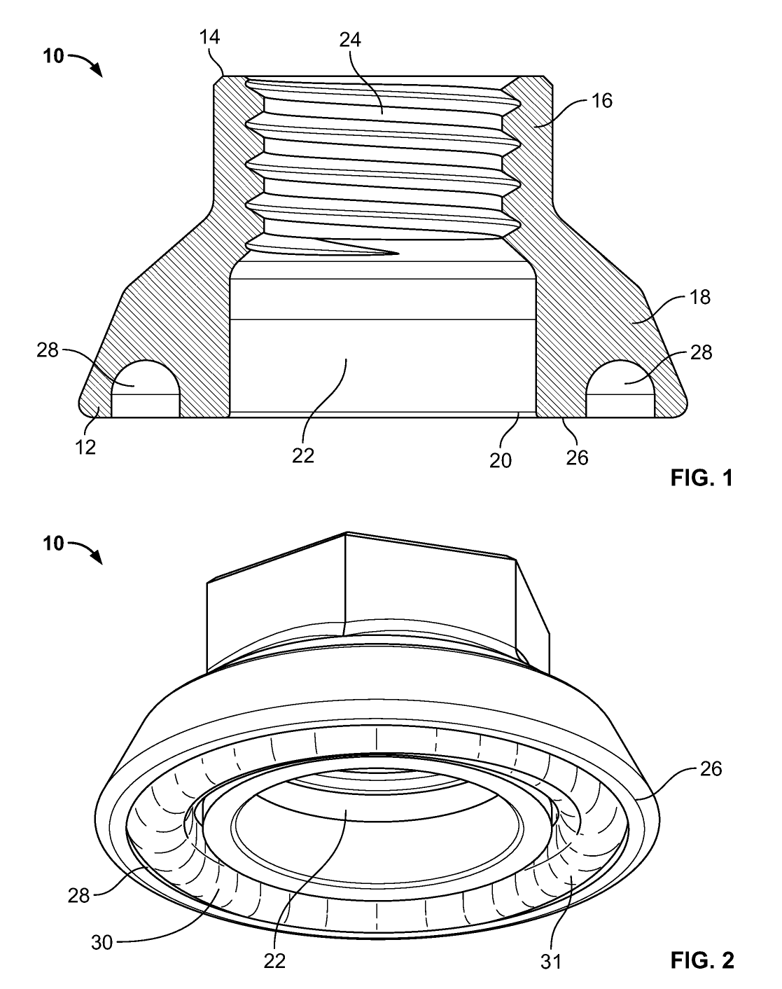

Referring to FIG. 1, in a first embodiment, a locking member 10 has a body including a first end 12, a second end 14 opposite the first end 12, a neck portion 16, and a flanged portion 18. In an embodiment, a diameter of the flanged portion 18 is greater than a diameter of the neck portion 16. In an embodiment, the locking member 10 is a nut having a neck portion 16 that is hexagonal to enable the neck portion 16 to be gripped and torqued with a tool (e.g., a wrench) during installation of the locking member 10 onto a threaded member (e.g., a bolt). In an embodiment, the locking member 10 is a swage collar having a neck portion 16 that is adapted to be engaged by a tool (e.g., a swage anvil) during installation of the locking member 10 onto a pin member. In an embodiment, a bore 20 extends from the first end 12 to the second end 14. In an embodiment, the bore 20 includes an open portion 22 extending from the first end 12 to a point intermediate the first and second ends 12, 14, and a threaded portion 24 extending from the intermediate point to the second end 14. It will be apparent to those of skill in the art that, in an embodiment of the locking member 10 that is a swage collar, the threaded portion 24 may be absent and the bore 20 may be substantially smooth throughout. In an embodiment, the flanged portion 18 includes a bearing surface 26 located at the first end 12. In an embodiment, the bearing surface 26 includes at least one channel 28 formed therein. In an embodiment, the channel 28 is annular and is concentric with and surrounds the bore 20. In certain embodiments, the locking member 10 is made from titanium, aluminum, nickel, steel, alloys including two or more metals, or other like metallic materials.

Referring to FIG. 2, a first insert 30 is positioned within the channel 28 of the locking member 10 of FIG. 1. In an embodiment, the first insert 30 has a ring-shape. In an embodiment, a surface 31 of the first insert 30 extends past the bearing surface 26 of the locking member 10 when the first insert 30 is positioned therein. In an embodiment, the channel 28 and the first insert 30 are sized and shaped so that the first insert 30 is secured within the channel 28 by a friction fit (e.g., an interference fit). In another embodiment, the first insert 30 is secured within the channel 28 by attachment using an epoxy medium, injected and adhered to the channel 28 during a curing process. In another embodiment, the first insert 30 is created using a particle deposition process within the channel 28 and is then cured.

In an embodiment, the first insert 30 is made from a material that allows for containment of plasma discharge caused by sparking. In an embodiment, the first insert 30 is made from a polymer. In another embodiment, the first insert 30 is made from an elastomer. In an embodiment, the polymer or elastomer first insert 30 can be created either through injection molding, additive manufacturing, or machining operations starting from a rod of the material (e.g., the polymer or elastomer) and processing such a rod to the desired shape. In another embodiment, the first insert 30 is made from a ceramic. In another embodiment, the first insert 30 is made from glass. In an embodiment, the ceramic or glass first insert 30 can be created from raw materials through machining processes. In an embodiment, the ceramic or glass first insert 30 can be formed in a specified mold. In another embodiment, the first insert 30 is made from a coated metal having a non-conductive coating layer. In an embodiment, the coated metal first insert 30 is first machined to a desired shape, and then receives a layer of non-conductive coating applied thereon. In certain embodiments, the non-conductive coating is a TEFLON® polytetrafluoroethylene (“PTFE”) coating, silicone, or a dielectric high voltage insulator. In an embodiment, the bearing surface 26 of the locking member 10 may include one or more channels in addition to the channel 28, with a total quantity of channels selected depending upon the amount of protection from plasma discharge that is required of the locking member 10.

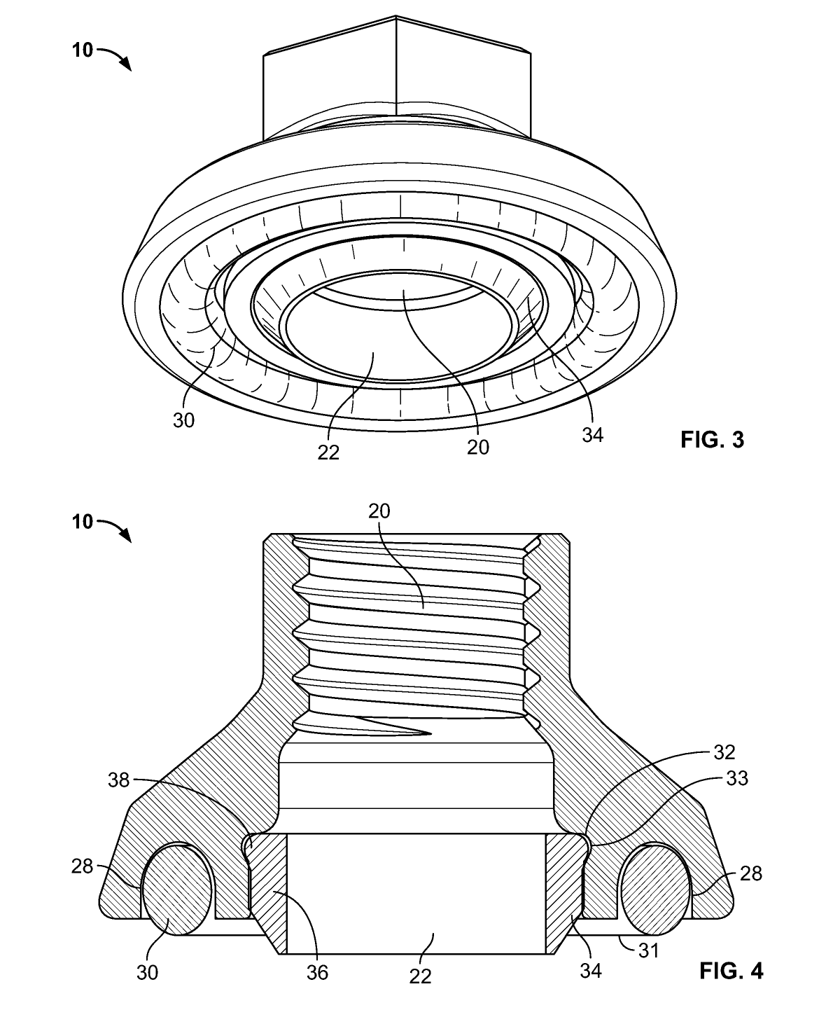

Referring to FIGS. 3 and 4, in a second embodiment, the open portion 22 of the bore 20 includes an enlarged counterbore 32 having an internal annular portion 33. In an embodiment, the counterbore 32 is sized and shaped to receive a second insert 34. In an embodiment, the second insert 34 includes a tubular portion 36 and a flanged portion 38, which engages the internal annular portion 33 of the counterbore 32. In an embodiment, the second insert 34 can be made from a material as described above with respect to the first insert 30 (e.g., polymer, elastomer, ceramic, glass, metal coated with a non-conductive layer, etc.). In an embodiment, the first insert 30 is made from a first material and the second insert 34 is made from the same, first material. In another embodiment, the first insert 30 is made from a first material and the second insert 34 is made from a second material that is different from the first material. For example, the second insert 34 may be constructed from a polymer and the first insert 30 may be constructed of a ceramic, or vice versa.

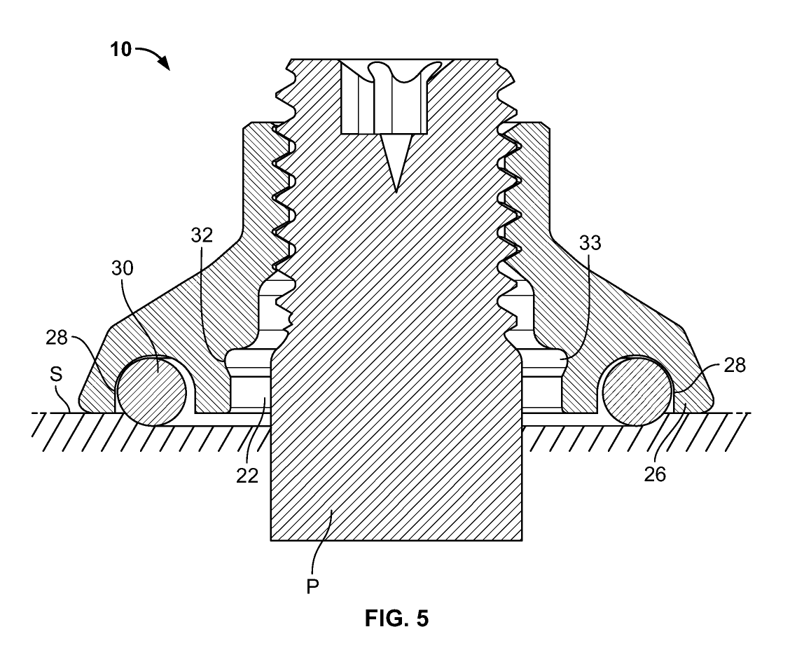

In an embodiment, as part of a fastener, the locking member 10 is adapted to be secured to a pin member or a bolt P (see FIG. 5) installed within aligned holes in a plurality of work pieces (not shown in the Figures), in order to secure such work pieces to one another. In an embodiment, the work pieces are formed of a composite material. In an embodiment, and except as noted herein, the fastener has a structure and function that are, or are similar to, the structure and function of the fasteners disclosed in U.S. Pat. No. 7,695,226 to March et al, the entirety of which is incorporated by reference herein.

In the event of a lightning strike, if sparking happens within the fastener, and hot gases and particles are ejected from the fastener holes, the inserts 30, 34 provide a deformable barrier that damps the spark material, trapping the particles and cooling the gases, preventing them from escaping to the outside of the locking member 10. Also, the choice of electrical conductivity of the inserts 30, 34 will allow for desired electrical flow criteria to be met during the case of a lightning strike to the fastener assembly.

Referring to FIG. 5, in another embodiment, the locking member 10 includes the enlarged counterbore 32 described above with reference to FIGS. 3 and 4, but the second insert 34 is not placed therein; however, the enlargement of the counterbore 32 allows for an increase in the volume of space housed between the counterbore 32, a pin/bolt P, and the fastened surface S of a work piece against which the locking member 10 bears. In an embodiment, the counterbore 32 is an empty void. In another embodiment, the counterbore 32 is filled with a crushable foam-like material with a very low material-to-air ratio less than or equal to 1 (not shown in the Figures). In an embodiment, the counterbore 32 acts as a pressure drop zone. This pressure drop zone, caused by the increase in volume, reduces the initial high pressure caused from sparking and plasma build-up. Reduction of pressure allows for less work needed to be performed by the first insert 30 located in the channel 28 of the bearing surface 26 of the locking member 10.

It should be understood that the embodiments described herein are merely exemplary and that a person skilled in the art may make many variations and modifications without departing from the spirit and scope of the invention. All such variations and modifications are intended to be included within the scope of the invention.

What is claimed is:

1. A locking member, comprising:
a body having a first end, a second end opposite said first end, a bore extending through said body from said first end to said second end, a bearing surface at said first end, fastening means for securing said locking member to a pin member, and a channel formed within said bearing surface and surrounding said bore; and
a first insert positioned within said channel, said first insert being adapted such that, when said locking member is secured against a surface of a workpiece, said first insert prevents passage of a sparking material from within said bore of said locking member.

2. The locking member of claim 1, wherein said fastening means includes a thread formed within at least a portion of said bore.

3. The locking member of claim 1, wherein said body includes a neck portion proximate said second end and a flanged portion proximate said first end, a diameter of said flanged portion being greater than a diameter of said neck portion.

4. The locking member of claim 3, wherein said neck portion is hexagonal.

5. The locking member of claim 1, wherein said body comprises one or more of titanium, aluminum, nickel, and steel.

6. The locking member of claim 1, wherein said first insert includes a material including one or more of a polymer, an elastomer, a ceramic, a glass, and a metal coated with a non-conductive layer.

7. The locking member of claim 6, wherein said non-conductive layer includes one or more of polytetrafluoroethylene, silicone, and a dielectric high voltage insulator.

8. The locking member of claim 1, wherein said first insert is friction fit within said channel, secured within said channel by an epoxy, or formed within said channel by deposition and curing.

9. The locking member of claim 1, wherein said body includes an enlarged counterbore extending from said first end to a point intermediate said first and second ends.

10. The locking member of claim 9, wherein said enlarged counterbore includes an annular portion proximate said point.

11. The locking member of claim 10, further comprising a second insert positioned within said enlarged counterbore.

12. The locking member of claim 11, wherein said second insert includes a flanged portion engaging said annular portion of said enlarged counterbore.

13. The locking member of claim 11, wherein said second insert includes a material including one or more of a polymer, an elastomer, a ceramic, a glass, and a metal coated with a non-conductive layer.

14. The locking member of claim 13, wherein said non-conductive layer of said second insert includes one or more of polytetrafluoroethylene, silicone, and a dielectric high voltage insulator.

15. The locking member of claim 13, wherein said material of said second insert is identical to said material of said first insert.

16. The locking member of claim 13, wherein said material of said second insert is different from said material of said first insert.

17. The locking member of claim 9, further comprising a foam-like material located within said counterbore.

18. The locking member of claim 17, wherein said foam-like material has a material-to-air ratio that is less than or equal to 1.

19. A fastener, comprising:
a pin member adapted to be installed within aligned holes in a plurality of workpieces; and
a locking member including:
a body having a first end, a second end opposite said first end, a bore extending through said body from said first end to said second end, a bearing surface at said first end, fastening means for securing said locking member to said pin member, and a channel formed within said bearing surface and surrounding said bore; and
an insert located within said channel, said insert being adapted such that, when said locking member is secured against a surface of one of the workpieces, said insert prevents passage of a sparking material from within said bore of said locking member.

20. The fastener of claim 19, wherein said locking member is one of a nut adapted to threadedly engage said pin member, and a swage collar adapted to be swaged onto said pin member.
